(19) United States
(12) Patent Application Publication
(10) Pub. No.: US 2017/0144383 A1
(43) Pub. Date: May 25, 2017

(54) Component of a Composite Material for a Motor Vehicle

(71) Applicant: Bayerische Motoren Werke Aktiengesellschaft, Muenchen (DE)

(72) Inventors: Roland MADLENER, Windach a. A. (DE); Klaus MEHRLICH, Fuerstenfeldbruck (DE)

(21) Appl. No.: 15/425,194

(22) Filed: Feb. 6, 2017

Related U.S. Application Data
(63) Continuation of application No. PCT/EP2015/068241, filed on Aug. 7, 2015.

(30) Foreign Application Priority Data
Aug. 7, 2014 (DE) 10 2014 215 714.5

(51) Int. Cl. B29C 67/24; B27N 3/02; B27N 3/04; B27N 3/00

(52) U.S. Cl. CPC B29C 67/24; B27N 3/007; B27N 3/002; B27N 3/02; B27N 3/04; B29K 2311/10

(57) ABSTRACT

In order to make a component for use in a motor vehicle recyclable in its entirety and at low cost, the component is molded from a particle and/or fiber composite material, which has a first component and a second component. The first component includes particles and/or fibers, which are produced from a first renewable raw material or a first mixture of a number of renewable raw materials. The second component is a matrix material, which is produced from a second renewable raw material or a second mixture of a number of renewable raw materials. The particles and/or fibers of the first component are held together by the matrix material of the second component and are for example mixed and/or embedded therein.

### CROSS REFERENCE TO RELATED APPLICATIONS

This application is a continuation of PCT International Application No. PCT/EP2015/068241, filed Aug. 7, 2015, which claims priority under 35 U.S.C. §119 from German Patent Application No. 10 2014 215 714.5, filed Aug. 7, 2014, the entire disclosures of which are herein expressly incorporated by reference.

### BACKGROUND AND SUMMARY OF THE INVENTION

The present invention relates to a component part produced from a composite engineering material, as for instance a structural component part or a visual-structural component part, for use in a motor vehicle.

Known visual and structural component parts of the type used to construct the interior of a motor vehicle are typically produced as composite engineering materials in a design that features a supporting part and a surficial and/or decorative part. The supporting part is self-supporting, has been formed into a predetermined shape and is primarily responsible for the shape of the component part. The decorative part sits on the supporting part as a component part surface which is visible to a user, and frequently consists of a different material than the supporting part. Such visual or structural component parts are frequently made as insert-molded composites. To confer the property of pleasant touch, for example soft touch, on the visible surface, an additional soft layer, as of a foam-type material for instance, may be provided between the decorative part and the supporting part. The layer is typically bonded to the decorative and supporting parts using an adhesive, frequently an adhesive based on polyurethane. DE 10 2004 025 570 A1 discloses a perceived high quality molded plastic part for use in a motor vehicle where the perceived high quality is due to the part's construction that features a support, a skin and inserted parts of foam.

Owing to the visual or structural component parts being made in an embodiment featuring a supporting part and a decorative part with or without a soft interlayer, the production of such component parts is burdensome. Furthermore, owing to the fact that various materials are being combined, any recycling of such visual or structural component parts is tricky as well as costly and time consuming.

The problem addressed by the present invention is that of providing a motor vehicle component part which is wholly recyclable, i.e., recyclable in its entirety, and inexpensive to produce.

This problem is solved by a component part and a method of producing such a component part in accordance with embodiments of the invention.

In a first aspect of the invention there is provided a component part for use in a motor vehicle, wherein the component part is formed from a particulate and/or fibrous composite engineering material comprising a first component and a second component. The first component comprises particles and/or fibers produced from a first renewable raw material or a first mixture of two or more renewable raw materials. The second component is a matrix material produced from a second renewable raw material or a second mixture of two or more renewable raw materials. In accordance with its function as a matrix material, the particles and/or fibers of the first component are held together by the matrix material of the second component. In particular, the particles and/or fibers of the first component may be mixed in and/or embedded in the matrix material of the second component.

It is a basic concept of the invention to produce not only the first but also the second component of the particulate and/or fibrous composite engineering material from renewable raw materials, and thus to provide a component part produced in its entirety from renewable raw materials. A component part of this type is wholly recyclable and complies with the principle of sustainability when the renewable raw materials derive from sustainable cultivation. A component part of this type further has a single-material constitution, i.e., is all one material and therefore easy to recycle. The omission of assembly steps for joining together a supporting component part and a decorative part renders the production of a component part according to the present invention time- and cost-effective.

The engineering material, which consists of the first component's particles and/or fibers mixed in and/or embedded in the matrix material of the second component, may initially, as an intermediate, be liquid or plastic to viscid, and as such be formable and/or curable. At the end of the component part production process, the engineering material and/or the component part produced therefrom has been formed into a predetermined shape and cured. This way of processing the engineering material is another reason why the production of the component part is time- and cost-effective.

The matrix material may be one of the following: (i) a vegetable-type organic raw material, (ii) a mixture of one or more vegetable-type organic raw materials, (iii) an animal-type organic raw material, (iv) a mixture of one or more animal-type organic raw materials, and (v) a mixture of at least one vegetable-type organic raw material and at least one animal-type organic raw material. The vegetable-type organic raw material may be lignin or starch; they are both natural polymeric materials capable of offering the functions of a matrix material, namely embeddability of fibers or particles of the first engineering material component and curability. The animal-type organic raw material may consist of boneglue or gelatin. In conventional particulate or composite engineering materials, the matrix material frequently consists of difficult-to-recycle plastics. In contradistinction thereto, the matrix material, essentially consisting of and/or produced from the raw materials described above, is straightforward to recycle.

In one embodiment, in which the engineering material is a fibrous composite engineering material, the fibers constituting the first component may be produced from vegetable-type organic fibers, for instance cotton, hemp, sisal, flax or riven wood, or from animal-type organic fibers, for instance fibers of animal wool, animal fur or animal hair. Component parts produced from such fibrous composite engineering materials and in combination with the matrix material described above, are wholly recyclable in a straightforward and cost-effective manner. Moreover, such (vegetable or animal) organic fibers, in their use as first component, endow the fibrous composite engineering material with advantageous properties as regards splintering resistance, elasticity and impact strength on the part of the ready-processed engineering material.

Vegetable-type organic fibers are derivable from fiber crops, as for instance the recited plant species of hemp, sisal or flax, from plant stems by destroying/dissolving the binder present therein and thus achieved detaching of the fibers. Proceeding for example from the raw material wood, vegetable-type organic fibers are derivable by riving, i.e., the tearing out of parts or fiber bundles in the longitudinal direction of tree trunks or branches.

In one embodiment, in which the engineering material is a fibrous composite engineering material, fibers constituting the first component may alternatively or additionally be provided in the form of spun threads, braided fiber bundles or rovings or of fibrous nonwoven webs, fiber mats, non-crimp fabrics or woven fabrics formed thereof.

The component part may be a visual-structural component part which may be formed as a self-supporting shaped structure and may have at least one visible surface. In this embodiment, which offers a single-material constitution and an absence of other materials, the design of visual-structural component parts is made easier and/or advantageous.

The component part may be produced from a component mixture which is shapeable and curable and which comprises essentially the first component and the second component.

The engineering material in addition to the first component may comprise textile fibers and/or woven textile fabrics as a further component embedded in the matrix, wherein the textile fibers and/or woven textile fabrics are produced from a third renewable raw material or a third mixture of two or more renewable raw materials. The textile fibers integrated in the engineering material and/or the woven textile fabric present therein prevents the component part from fragmenting and/or the engineering material from splintering in the event of a crash.

The component part may be produced from the engineering material to be entirely of one material. In this embodiment, the component part is particularly straightforward to recycle.

Alternatively, the component part may have a structure having a multi-ply construction. The multi-ply structure may comprise at least a first ply and a second ply. The first ply may comprise an entirely one-material cured particulate and/or composite engineering material. The second ply may comprise a layer or a plurality of layers of a fibrous nonwoven web, woven fabric or non-crimp fabric produced from fibers, or a layer or a plurality of layers of fiber mats, wherein the layer or the plurality of layers are embedded in a matrix material. Multi-ply component parts may be produced with a particularly stiff second ply arranged underneath the first ply constituting the surface of the component part, and thus offer not only an advantageous stiffness (due to the second ply) but also a visually attractive embodiment and/or appearance for the visible surface of the component part (mediated by the first ply).

In a structure having a multi-ply construction, one ply (advantageously the ply constituting the visible surface) may be produced from a thin layer of veneer wood as first component, impregnated with or embedded in a matrix material of the present invention as second component. A ply thus produced to constitute the visible surface of the component part endows the component part with a particularly appealing and natural appearance.

According to a second aspect of the invention there is provided a method of producing a component part having a predetermined shape for use in a motor vehicle. The method comprises the acts of:
(a) providing a first engineering material component comprising particles and/or fibers produced from a first renewable raw material or a first mixture of two or more renewable raw materials,
(b) providing a second engineering material component comprising matrix material produced from a second renewable raw material or a second mixture of two or more renewable raw materials,
(c) mixing the first engineering material component and the second engineering material component together to form a component mixture,
(d) forming the component mixture into the shape of the component part, and
(e) curing the formed component mixture.

This method provides the same advantages as attainable with a component part in the embodiment according to the first aspect of the invention.

The act of forming in step (d) may comprise one or more of the following forming or molding processes: injecting, pressing, casting, diecasting, injection molding, extrusion blow molding, extrusion, extrusion press molding, rolling, push-through pressing, as for instance strand pressing and flow molding, and pultrusion. The omission of assembly steps for joining together a supporting component part and a decorative part renders the production of a component part in the manner of the present invention time- and cost-effective.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic perspective view of a formed visual and structural component part according to one embodiment of the invention.

FIG. 2 is a schematic perspective view of a component part, consisting of a plurality of different plies, in a further embodiment of the invention.

### DETAILED DESCRIPTION OF THE DRAWINGS

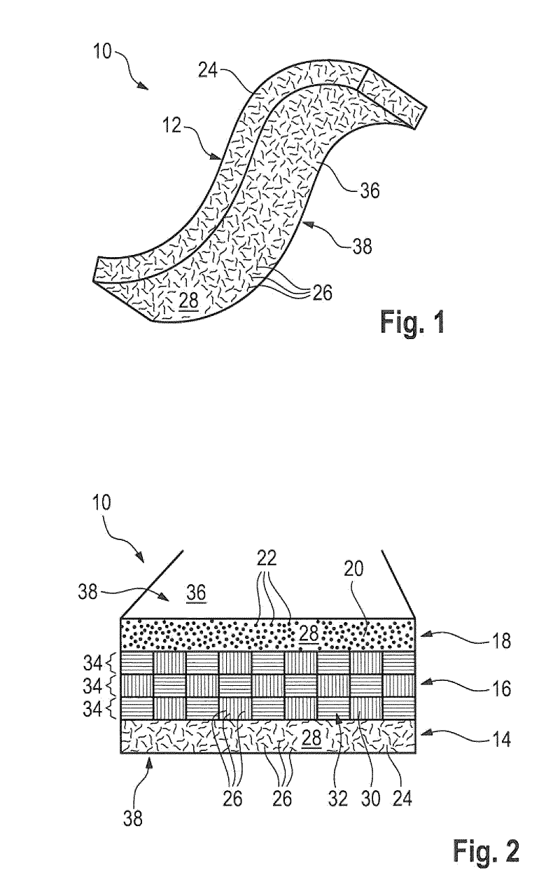

The component part shown at 10 in FIG. 1 is intended for use in a motor vehicle as a visual-structural part 12. The component part 10 has been formed essentially completely from a fibrous composite engineering material 24 and cured. In a departure from what is shown in FIG. 1, the component part 10 could be formed from a particulate composite engineering material (not shown) and cured. In either case, the component part 10 is an entirely one-material part 38, is self-supporting and (after installation) has a user-visible surface 36.

When the component part 10 is formed from a particulate and/or fibrous composite engineering material, the engineering material comprises a first engineering material component and a second engineering material component. The first component comprises particles 22, as shown in FIG. 2 in the third ply 18 of a component part having a multi-ply construction, and/or fibers 26, as with the component part 10 shown in FIG. 1 or in the first ply 14 of the component part shown in FIG. 2 as having a multi-ply construction. According to the present invention, the particles 22 and the fibers 26 have been produced from a first renewable raw material or a first mixture of two or more renewable raw materials.

The second component of the component part shown in FIG. 1 is a matrix material 28. According to the present invention, the matrix material 28 has been produced from a second renewable raw material or a second mixture of two or more renewable raw materials.

The particles 22, as in the third ply 18 of the multi-ply component part in FIG. 2, and/or the fibers 26, as in component part 10 in FIG. 1 and in the first ply 14 of the multi-ply component part in FIG. 2, of the first component of the engineering material are held together by the matrix material 28 of the second component and, more particularly, are mixed in and/or embedded therein.

The engineering material used in the component part 10 shown in FIG. 1 and in the plies 14, 16 and 18 of the multi-ply component part 10 shown in FIG. 2 thus consists in each case of the first component's particles 22 and/or fibers 26 mixed in and/or embedded in the matrix material 28 of the second component. The engineering material is initially provided in a formable and curable, for instance plastically deformable or liquid, form. In the course of its processing, it is initially formed into a predetermined outer shape and then cured in this outer shape. At the end of its processing, the engineering material has been formed into its predetermined shape and cured.

The visual-structural component part 12 shown in FIG. 1 is produced from the engineering material comprising renewable, natural raw materials to be entirely of one material.

The component part 10 shown in FIG. 2 has a structure having a multi-ply construction. It comprises a first ply 14, a second ply 16 and a third ply 18.

The first ply 14 has been prefabricated from an entirely one-material particulate composite engineering material 20. The second ply 16 comprises a plurality of layers 34 (three layers in FIG. 2) of a woven fabric 32 produced from fibers 26, the layers 34 being embedded in a matrix material (not designated). The third ply 18 has been prefabricated from an entirely one-material fibrous composite engineering material 24. The prefabricated plies 14, 16 and 18 are joined together to form a multi-ply structure, as shown in FIG. 2, wherein the second ply 16 is sandwiched between the first ply 14 (at the bottom in FIG. 2) and the third ply 18 (at the top in FIG. 2). The multi-ply composite was subsequently formed (laid up) in its outer shape, planar for example in FIG. 2, and cured.

In the embodiments shown in FIGS. 1 and 2, the matrix material 28 has been produced either from a vegetable-type organic raw material or from an animal-type organic raw material. The vegetable-type organic raw material may be lignin or starch or a mixture thereof. The animal-type organic raw material may be boneglue or gelatin or a mixture thereof.

According to the origin (vegetable or animal) of the raw material for the matrix material 28, the fibers 26 or the particles 22, which constitute the first component of the respective engineering material, have been produced from vegetable-type organic fibers or from animal-type organic fibers. The vegetable-type organic fibers may be produced from cotton, hemp, sisal, flax or riven wood or from a mixture thereof. The animal-type organic fibers may have been produced from animal wool, from animal fur or from animal hair or from a mixture thereof.

### LIST OF REFERENCE SIGNS

10 component part

12 visual-structural component part

14 first ply

16 second ply

18 third ply

20 particulate composite engineering material

22 particles

24 fibrous composite engineering material

26 fiber

28 matrix material

30 roving

32 woven fabric

34 layer

36 visible surface

38 entirely one-material part

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A component part for use in a motor vehicle, comprising:
a particulate and/or fibrous composite engineering material comprising a first component and a second component that form the component part, wherein:
the first component comprises particles and/or fibers produced from a first renewable raw material or a first mixture of two or more renewable raw materials,
the second component is a matrix material produced from a second renewable raw material or a second mixture of two or more renewable raw materials, and
the particles and/or fibers of the first component are held together by the matrix material of the second component.

2. The component part according to claim 1, wherein
the engineering material, composed of the first component's particles and/or fibers mixed in and/or embedded in the matrix material of the second component, is formable and/or curable.

3. The component part according to claim 1, wherein the matrix material is selected from a group consisting of:
a vegetable-type organic raw material,
a mixture of one or more vegetable-type organic raw materials,
an animal-type organic raw material,
a mixture of one or more animal-type organic raw materials, and
a mixture of at least one vegetable-type organic raw material and at least one animal-type organic raw material.

4. The component part according to claim 3, wherein
the vegetable-type organic raw material is lignin or starch, and
the animal-type organic raw material is bone glue or gelatin.

5. The component part according to claim 1, wherein
the engineering material is a fibrous composite engineering material wherein fibers constituting the first component are produced from vegetable-type organic fibers or from animal-type organic fibers.

6. The component part according to claim 3, wherein
the engineering material is a fibrous composite engineering material wherein fibers constituting the first component are produced from vegetable-type organic fibers or from animal-type organic fibers.

7. The component part according to claim 6, wherein
the vegetable-type organic fibers are fibers of cotton, hemp, sisal, flax, or riven wood, and the animal-type organic fibers are fibers of animal wool, animal fur, or animal hair.

8. The component part according to claim 1, wherein
the engineering material is a fibrous composite engineering material wherein fibers constituting the first component are provided in the form of spun threads, braided fiber bundles or rovings or of fibrous nonwoven webs, fiber mats, non-crimp fabrics or woven fabrics formed thereof

9. The component part according to claim 3, wherein
the engineering material is a fibrous composite engineering material wherein fibers constituting the first component are provided in the form of spun threads, braided fiber bundles or rovings or of fibrous nonwoven webs, fiber mats, non-crimp fabrics or woven fabrics formed thereof

10. The component part according to claim 1, wherein
the component part is a visual-structural component part formed as a self-supporting shaped structure and adapted to have at least one visible surface.

11. The component part according to claim 1, wherein
the component part is produced from a component mixture which is shapeable and curable and which consists essentially of the first component and the second component.

12. The component part according to claim 1, wherein
the engineering material, in addition to the first component, comprises textile fibers and/or woven textile fabrics as a further component embedded in the matrix, and
the textile fibers and/or woven textile fabrics are produced from a third renewable raw material or a third mixture of two or more renewable raw materials.

13. The component part according to claim 1, wherein
the component part is produced from the engineering material to be entirely of one material.

14. The component part according to claim 1, wherein
the component part has a structure with a multi-ply construction.

15. The component part according to claim 14, wherein the multi-ply construction comprises at least a first ply and a second ply, wherein:
the first ply comprises an entirely one-material cured particulate and/or composite engineering material, and
the second ply comprises a layer or a plurality of layers of a fibrous nonwoven web, woven fabric or non-crimp fabric produced from fibers, or a layer or a plurality of layers of fiber mats, wherein the layer or the plurality of layers are embedded in a matrix material.

16. A method of producing a component part having a predetermined shape for use in a motor vehicle, the method comprising the acts of:
(a) providing a first engineering material component comprising particles and/or fibers produced from a first renewable raw material or a first mixture of two or more renewable raw materials;
(b) providing a second engineering material component comprising a matrix material produced from a second renewable raw material or a second mixture of two or more renewable raw materials;
(c) mixing the first engineering material component and the second engineering material component together to form a component mixture;
(d) forming the component mixture into the shape of the component part; and
(e) curing the formed component mixture.
